(19) United States
(12) Patent Application Publication
(10) Pub. No.: US 2002/0163272 A1
(43) Pub. Date: Nov. 7, 2002

(54) STATOR FOR A ROTATING ELECTRIC MACHINE AND A METHOD OF MANUFACTURING A STATOR

(76) Inventors: BERTIL LARSSON, VASTERAS (SE); BENGT ROTHMAN, VASTERAS (SE); HANS-OLOF KALLDIN, VASTERAS (SE); MATS LEIJON, VASTERAS (SE); SOREN BERGGREN, VASTERAS (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/297,606

(22) PCT Filed: Nov. 4, 1997
(86) PCT No.: PCT/SE97/01840

(30) Foreign Application Priority Data
Nov. 4, 1996 (SE) 9604026-6
Oct. 13, 1997 (SE) 9703718-8

(51) Int. Cl. H02K 1/00

(52) U.S. Cl. 310/180

(57) ABSTRACT

The present invention relates to a stator for a rotating electric machine, comprising a stator, with a stator core and a winding, and a rotor, wherein said stator core is provided with stator teeth extending radially inwards, towards said rotor, characterized in that each stator tooth (3) is configured as a number of tooth sections (7) joined axially into a stator tooth plank (2) and that a number of stator tooth planks are fitted together side by side thus forming a section (1A, 1B, 1C, 1D; 31, 32, 33, 34) of a stator core or a complete stator core. The invention also relates to a corresponding method for use in the manufacturing of a stator, and a rotating electric machine including such a stator.

The present invention relates to a stator for a rotating electric machine in accordance with the introductory part of claim 1, a method for use in the manufacturing a stator for a rotating electric machine in accordance with the introductory part of claim 34, as well as a rotating electric machine in accordance with claim 57.

Examples of rotating electric machines which are relevant in the context of the present invention comprise synchronous machines, ordinary asynchronous machines, double-fed machines, applications for asynchronous converter cascades, external pole machines and synchronous flux machines, as well as alternating current machines, which primarily are intended to be used as generators in power stations for the generation of electric power.

In the following, mostly synchronous machines are discussed, but it should be noted that the present invention is not limited to such machines.

Most synchronous machines, according to conventional prior art, have a field winding in the rotor, where the main flux is generated by direct current, and an AC winding in the stator. Stator frames for large synchronous machines are often made of steel sheet with a welded construction. The laminated core is normally made from enamelled 0.35 or 0.5 mm electric sheet. For radial ventilation and cooling, the laminated core, at least for medium-large and large machines, is divided into stacks with radial ventilation ducts. For larger machines, the sheet is punched into segments, which are attached to the stator body by means of wedges/dovetails. The laminated core is retained by pressure fingers and pressure plates. The stator winding is disposed in slots in the laminated core, which normally have a cross section in the form of a rectangle or a trapezoid.

One major disadvantage with larger stator cores according to the prior art is the problem of manufacturing and also transporting such cores. According to convention, the complete stator core, with the frame, is manufactured in a workshop. In order to be able to transport the stator core to the site of installation, the core is then divided into as few core sections as possible, with consideration taken to the transportation facilities. On the site of installation, the core sections are assembled and held together and secured by means of the stator frame, which may comprise several frame sections assembled together. The winding may be installed on the site or partly in the workshop. An alternative, especially for very large sized machines, is to perform more of the manufacturing steps of the stator core on the site of installation, including assembling the punched electric sheets of the core, assembling the core in the stator frame, but not including punching the sheets.

Rotating electric machines have, according to conventional prior art, been designed for voltages in the interval 6-30 kV, where 30 kV normally has been regarded as an upper limit. In the case of a generator, this would normally mean that a generator must be connected to the power network via a transformer, which transforms the voltage up to the level of the power network, which will be in the range of 130-400 kV.

During the years, certain attempts have been made to develop especially synchronous machines, in particular generators, for higher voltages. Examples of this are described in “Electrical World”, Oct. 15, 1932, pp 524-525, the article “Water-and-Oil-cooled Turbogenerator TVM-300” in J. Elektrotechnika, No. 1, 1970, pp 6-8, and the patent publications U.S. Pat. No. 4,429,244 and SU 955 369. Unfortunately, none of these have been successful and they have not resulted in any commercially available products.

It appears, however, that it is possible to use high voltage insulated electric conductors with permanent insulation, similar to cables used for transmitting electric power (such as XLPE cables), as a stator winding in a rotating electric machine. Thereby, the voltage of the machine may be increased to such levels that it may be connected directly to the power network, without any intermediate transformer. Such an insulated conductor or cable is flexible and it is of a kind which is described more in detail in the PCT applications SE97/00874 and SE97/00875. Additional descriptions of the concerned insulated conductor or cable can be found in the PCT applications SE97/00901, SE97/00902 and SE97/00903.

From U.S. Pat. No. 5,036,165 is previously known a cable comprising a conductive core surrounded by two semiconducting layers and an intermediate layer of solid insulation. However, this known cable is not intended for use with high voltages and it is, for several reasons, impossible or not suitable to apply in the present invention. Primarily, this is due to the fact that the known cable is of the rigid type, i.e. the layers surrounding the core are reinforced or armoured in such a way that the cable is not flexible and it will not be possible to bend the cable. If an effort is made to bend the cable, ruptures will occur between the layers, which will also be the case if the cable is subjected to thermal expansion.

The object of the present invention is to solve the above mentioned problems and to provide a stator for a rotating electric machine of the above indicated type, which stator is designed in such a way that a new and very flexible manufacturing method will be made possible. The object is also to provide a manufacturing method for a stator as well as a rotating electric machine including the stator.

The object is achieved by means of a stator as described in the introductory part of claim 1, being characterized according to the advantageous features indicated in the characterizing part of said claim. A corresponding method is defined in the characterizing part of claim 34. Finally, the object is also achieved by means of a rotating electric machine in accordance with claim 57, comprising a stator as defined in any one of the claims regarding the stator.

Accordingly, through the feature that each stator tooth is configured with a number of tooth sections joined axially into a stator tooth plank and that a number of stator tooth planks are fitted together side by side thus forming a section of a stator core or a complete core, is achieved the important advantage that the stator core may be built in sections, where each section may vary from comprising only one tooth plank up to as many tooth planks as is desired from case to case. This means that, if the shape of the complete core may be schematically described as a hollow cylinder, the expression “core section” should be understood to mean a sector of that hollow cylinder. In principle, any section size may be foreseen, determined by manufacturing or transportation aspects. In addition, the feature that an electric field is generated which is enclosed or contained within the winding for at least one turn of the winding has the considerable advantage that the electric field will be near zero in the coil-end region outside the winding and that the electric field outside the winding need not be controlled. In other words, the electric field is already controlled in this way. This means that no field concentrations can be obtained, neither within the core, nor in the coil-end region, nor in the transition therebetween.

According to a further advantageous feature, a number of sections of a stator core are joined together in order to achieve a complete stator core. Thus a near complete flexibility is achieved when building stator cores. For example, core sections of any chosen size may be premanufactured and then transported to the installation site of the machine, where the final assembly of the core is made. The sections may be provided with a winding either during the premanufacturing process, in which case the windings of the different core sections will later have to be connected, or on the installation site, in which case preferably the entire winding is installed in one operation. A particular advantage achieved by this is that the transportation is facilitated through not having to transport large stator core sections. This will also have the advantage that it will be possible to manufacture larger stator cores in general and particularly on the installation site.

The new stator design according to the present invention is particularly advantageous for stators of a large diameter, for in example hydro-generators.

The stator teeth are preferably manufactured from layers of punched electric sheet, which are glued together. The electric sheet in question is preferably an enamelled sheet pasted with some sort of glue or adhesive. A tooth section is made up of a number of layers of electric sheet, generally several hundreds of layers. However, it is also possible that the teeth are made from some other type of material. The tooth sections are then assembled (or stacked) into the so-called tooth plank which constitutes the actual tooth. Preferably the tooth sections are glued together in order to form the plank and any residue of glue in the slots in the tooth sections is eliminated by means of blasting. The metal in the slots is consequently clean, which is advantageous as will be apparent later on.

Another advantage is that the present invention even makes it possible to manufacture the stator core from scratch on the installation site. This is possible since the punched steel sheets making up the tooth sections are so small that it is not impracticable to arrange for a punching machine to produce the sheets on the installation site.

Another important feature of the stator according to the present invention resides in the fact that the winding is provided by means of an insulated conductor which comprises at least one current-carrying conductor, a first layer having semiconducting properties provided around said conductor, a solid insulating layer provided around said first layer, and a second layer having semiconducting properties provided around said insulating layer. Advantageously this insulated conductor is a cable, preferably a high voltage cable.

Through the use of high voltage insulated electric conductors, in the following referred to as high voltage cables or power cables, with solid insulation of a similar design as previously known cables used for the transmission of electric power (for example so called XLPE cables or cables with rubber insulation), the voltage of the machine may be increased to such levels that it may be directly connected to the power network without passing over a transformer. This leads to the very important advantage that the conventional transformer may be eliminated. Consequently, the solution according to the present invention represents major savings both in economic terms and regarding space requirement and weight for generator plants and other installations comprising rotating electric machines.

To be able to cope with the problems which arise in case of direct connection of rotating electric machines to all types of high-voltage power networks, a machine according to the invention may have a number of features which significantly distinguishes it from the state of the art both as regards conventional mechanical engineering and the mechanical engineering which has been published during the last few years. Some will follow below.

According to a preferred embodiment the insulated conductor or cable is flexible. This feature is important in order to be able to use the cable as a winding. To continue, the first semiconducting layer is substantially at the same potential as the current-carrying conductor. The second semiconducting layer is preferably arranged to constitute a substantially equipotential surface surrounding said conductor and the insulation layer.

The use of a cable with an outer semiconducting layer has the advantage that it permits the outer layer of the winding, in its full length, to be maintained at ground potential. Consequently, the claimed invention may have the feature that the outer semiconducting layer is connected to ground potential. As an alternative, the outer layer may be cut off, at suitable locations along the length of the conductor, and each cut-off part length may be directly connected to ground potential. It is also possible to connect the outer semiconducting layer to another predetermined potential.

A considerable advantage with having the outer layer connected to ground potential is that the electric field will be near zero in the coil-end region outside the outer semiconductor and that the electric field need not be controlled, as has already been explained.

According to other features at least two adjacent layers have substantially equal thermal expansion coefficients.

As a further advantage, each of said three layers, i.e. the two semiconducting layers and the insulation layer, may be solidly connected to the adjacent layer along substantially the whole connecting surface. According to yet another, particularly important feature, said layers are arranged to adhere to one another even when the insulated conductor or cable is subjected to bending.

As yet another advantageous feature the current-carrying conductor/conductors may comprise both non-insulated and insulated strands, stranded into a number of layers. As an alternative, the strands may be transposed into a number of layers. The mixture of both insulated and non-insulated stranded strands or, alternatively, transposed strands entail low additional losses.

Preferably, cables with a circular cross section are used. They have the advantage of bending more easily as well as displaying better electric properties. However, in order to obtain, among other things, better packing density, cables with a different cross section may be used. Finally, it may be mentioned that the cable by preference has a diameter in the interval of 20-250 mm and a conducting area in the interval of 80-3000 mm².

According to one advantageous embodiment the stator is further characterized in that the stator tooth comprises a forward tooth portion facing inwards, towards the rotor, when mounted in the stator, and a yoke (rear) portion facing outwards, that said stator tooth has two opposite lateral sides each facing the corresponding side of an adjacent stator tooth, that the lateral sides of the tooth portion facing inwards are provided with slots for the winding and that at least one of the lateral sides of the yoke portion is provided with a lining made of a resilient material.

To provide the side of the yoke portion of the stator tooth with a lining made of a resilient material has the considerable advantage that it facilitates the application of the winding in the winding slots. Since, by means of the resilient material, there will occur a certain play between the sides of two adjacent tooth planks the slot openings will be larger. This will have the advantageous result that more space will be available for the winding and the insertion of the winding is facilitated.

As an alternative the lining may be replaced by a separate lining element of a resilient material which is inserted between the lateral sides of the yoke portions of two adjacent stator teeth.

According to a preferred embodiment of the invention, the stator is characterized in that it comprises compressing means for tangentially compressing the teeth of the stator, thereby providing a prestressing at the innermost end of the teeth. This feature provides the advantage of providing additional mechanical stiffness and preventing vibrations due to oscillations of the teeth.

According to another advantageous feature, the stator is characterized in that at least one longitudinal axial notch is arranged in the tooth plank, along its innermost side and facing the rotor, and that a key element of a non magnetic material is positioned in said notch in order to prevent lateral oscillations of said tooth plank and/or the adjacent tooth plank. The risk for lateral oscillations of the tooth planks is mainly due to their length and this risk may be eliminated by means of said key elements which are prestressed by the compression means. The key elements should be stiff in order to permit the above mentioned prestressing of the innermost end of the teeth. In a variant, the notch may be provided with a lining of a resilient material, such as rubber. The purpose of this is to match the stiffness of the innermost end of the teeth with the stiffness in the yoke portion of the teeth/core, in order to obtain an even load distribution and thereby a uniform prestressing of the different parts of the teeth. It may also have certain advantages regarding the ability to absorb thermal movements, as is described below.

According to a first embodiment the compression means are provided by means of a stator frame surrounding the completed stator core, whereby said frame holds the stator teeth of the core and the core sections in place. As a particularly advantageous feature the frame is provided with at least one longitudinal axial opening and includes at least one means for tightening said frame around the stator core by means of reducing said opening. As an alternative, the stator is characterized in that the stator frame is divided into at least two frame sections, and preferably more than two, that a longitudinal axial opening is created between the frame sections, and that means are provided connecting the frame sections and for tightening said frame around the stator core by means of reducing said openings. The means for connecting the frame sections and for the tightening of the frame is preferably a combined means fulfilling both functions. The number of connection/tightening means is preferably equal to the number of frame sections.

Preferably, said tightening means includes a bolted joint, or equivalent means.

As a further feature, the stator frame includes a springing means associated with said tightening means, and, by means of said springing means, the opening/openings in the stator frame and the winding slots are automatically adjusted to thermal expansions and contractions of the winding. The combined arrangement with the lining and/or the lining elements and the springing means associated with the stator frame has a very advantageous effect. When the tightening means is used to tighten the stator frame around the stator core, the linings or lining elements are compressed and the cable is brought into contact with the wall of the slot in the stator teeth. When the cable is heated up it will expand and the stator teeth will be pressed apart and the mentioned springing means will be compressed. This has the advantage that the risk of the cable being deformed when it expands inside the slots is avoided since the space available for the cable in the slots will adjust to the cross section of the cable, against the action of the springing means. It is also conceivable that the resilient material, which preferably is rubber, will expand when heated up. When the temperature falls the springing means will then make sure that the stator frame and the core is compressed back to its original state, and consequently also the space available for the cable in the slots will be reduced. This has the advantage that it will be possible to absorb and handle thermal movements in the system in a controlled manner. It also serves to fixate the winding in the slots.

As mentioned rubber is one possible choice for the resilient material, other examples are synthetic rubber, plastics, resinous materials, etc.

According to a second embodiment, the compressing means includes a structure of prestressing means, arranged along the circumference of the core, and brackets arranged axially for distributing the compressive force to the core. Preferably said prestressing means includes rods or wires. This embodiment has the particular advantage that the traditional stator frame may be excluded, and thereby the space required for the stator is reduced. According to a preferred feature, the stator also comprises a base upon which the core is supported. It also has the advantages described above regarding adaptation to thermal movements etc.

According to a third embodiment, the core sections may be held together by means of clamping rings in the form of self-supporting steel bands or hoops similar to the type used for barrels.

It may be noted that, while the first embodiment with the stator frame also contributes to the stability and stiffness of the stator, the compression means according to embodiments two and three more or less exclusively function as prestressing means, and therefore the core must be sufficiently stiff by itself. It may also be possible to combine the third embodiment with the previously mentioned two embodiments.

It is also possible to provide electrical insulation between each tooth in order to avoid contact between one layer of laminations and another in an adjacent tooth.

According to a particularly advantageous feature, each tooth section and thus each stator tooth plank may be provided on both lateral sides with guiding means designed to fit against corresponding guiding means of corresponding shape on adjacent stator tooth planks. This feature will facilitate the assembly of the tooth sections in alignment with each other.

The manufacturing method according to the present invention includes steps corresponding to the described features of the stator, in particular axially joining a number of tooth sections into a stator tooth plank, thereby forming said stator tooth; fitting, side by side, a number of stator tooth planks, thereby forming a section of a stator core or a complete stator core; and providing a winding within which a generated electric field is enclosed or contained for at least one turn of said winding.

As a particular advantage it may be characterized in inserting the winding in the axial direction of the stator core.

According to a particularly advantageous embodiment, the winding is manufactured in a fixture in which the winding can be inserted from the yoke side of the fixture/stator, into removable, temporary, smooth teeth arranged in the fixture. The permanent teeth are applied one by one in the fixture as the temporary teeth are removed one by one, so that the windings gradually fall down into the slots. The whole stack is subsequently impregnated. The sections are compressed on site with tangentially applied strips or wires or equivalent means.

The winding can thus be completely finished in the fixture where the slots are open towards the yoke and have smooth sides. Upon assembly the lowermost temporary tooth, which is smooth, is removed. The cables, comprising for instance ten winding parts in a slot (may be more or less), fall or are pressed down about one slot pitch against a support in the fixture. This provides space for insertion of the lowermost proper tooth between the cables and the almost smooth tooth. The same procedure is then repeated for each tooth. Since the temporary teeth define the slots in the fixture these have smooth sides which are open towards the yoke side.

Further features and advantages of the present invention will be apparent from the remaining dependent claims.

As a summary, the present invention has the advantage that it provides a unique and very flexible system with individual stator teeth, in which each stator tooth is manufactured separately and is a separate element. This facilitates the construction of stators by means of core sections, built from any suitable number of teeth. The result is a stator core that is both simple with regard to the manufacturing method and easy to transport and install on the final site of operation. Furthermore, the present invention has the advantage that it may be used both in connection with windings of the conventional type and with windings comprising high voltage cables. However, it is primarily intended for use with high voltage cables, and a typical working area for the invention ranges from 36 kV up to 800 kV, preferably 72,5 kV-800 kV. Secondarily, it is intended for voltages below 36 kV.

The invention will now be described in detail with reference made to preferred embodiments illustrated in the enclosed drawings, in which:

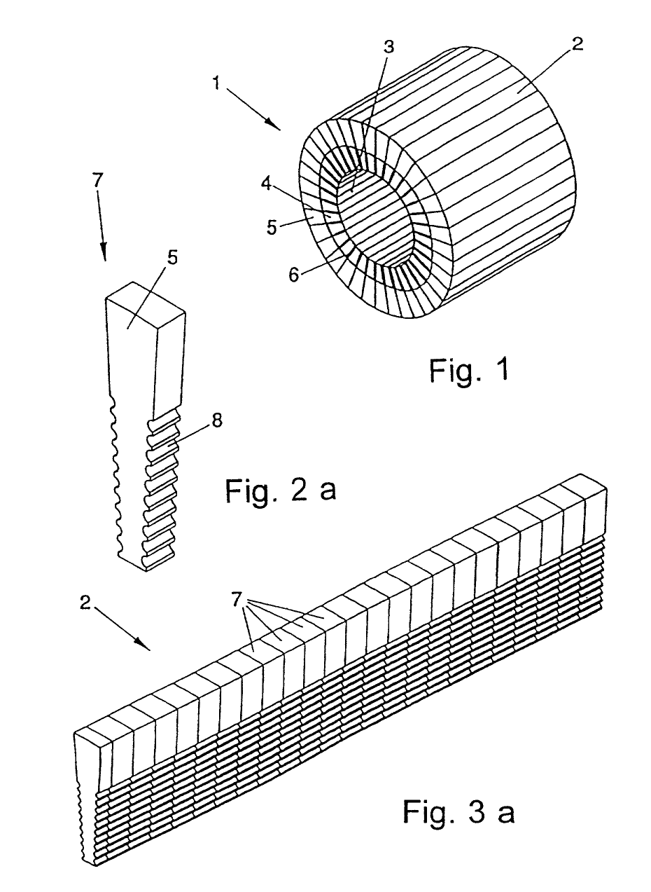

FIG. 1 shows a schematic view in perspective of a stator according to the present invention,

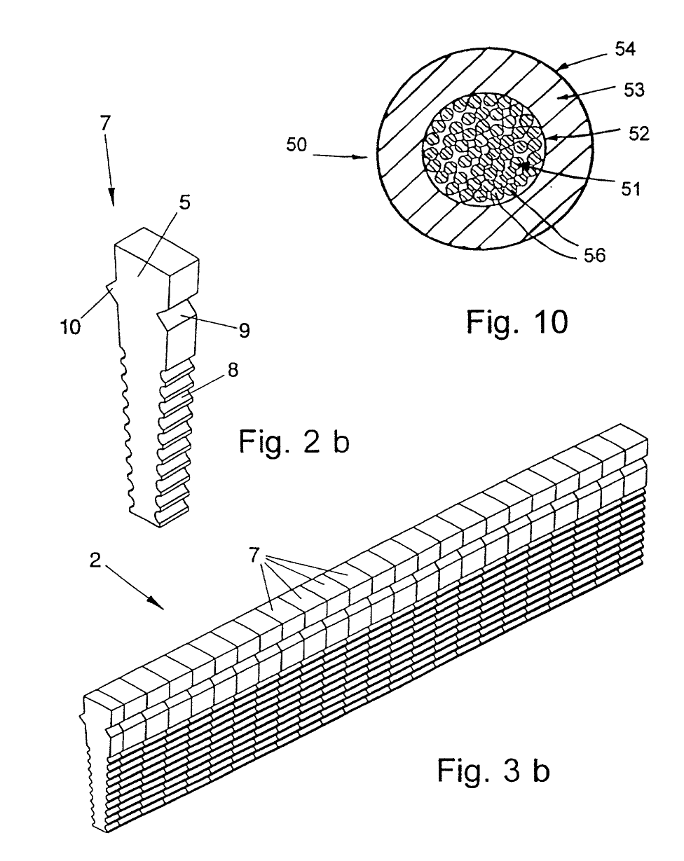

FIG. 2a shows a schematic view in perspective of a first variant of a tooth section according to the present invention,

FIG. 2b shows a schematic view in perspective of a second variant of a tooth section according to the present invention,

FIG. 3a shows a schematic view in perspective of a first variant of a tooth plank, comprising tooth sections according to FIG. 2a,

FIG. 3b shows a schematic view in perspective of a second variant of a tooth plank, comprising tooth sections according to FIG. 2b,

FIG. 4 shows a schematic front view of a first embodiment of a stator according to the present invention,

FIG. 5 shows a front view of a detail in the stator in FIG. 4,

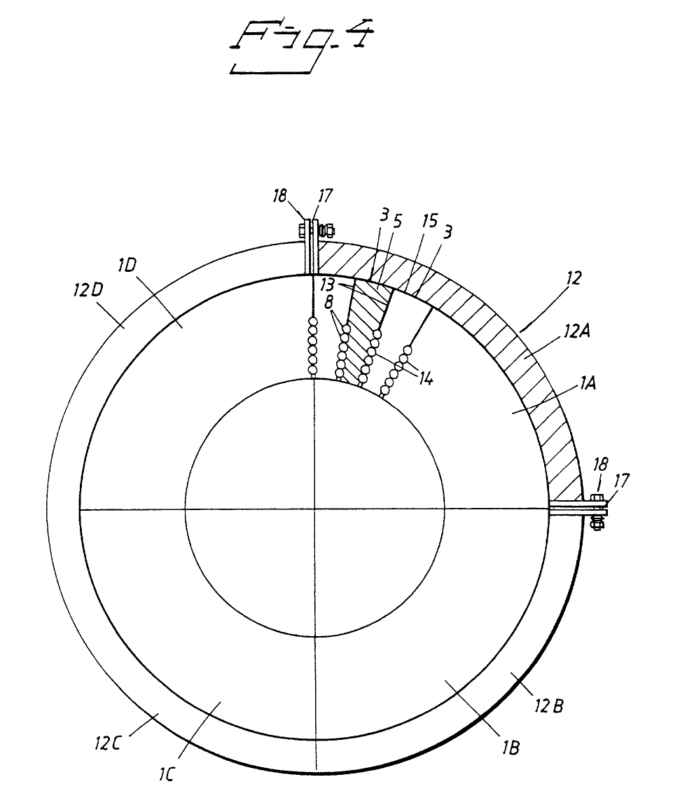

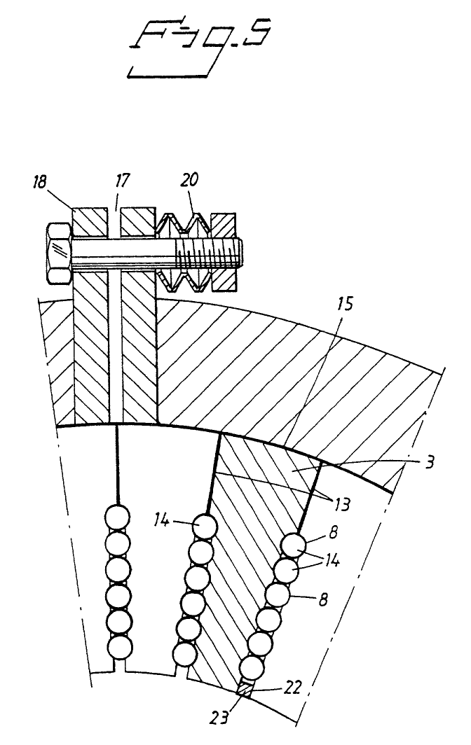

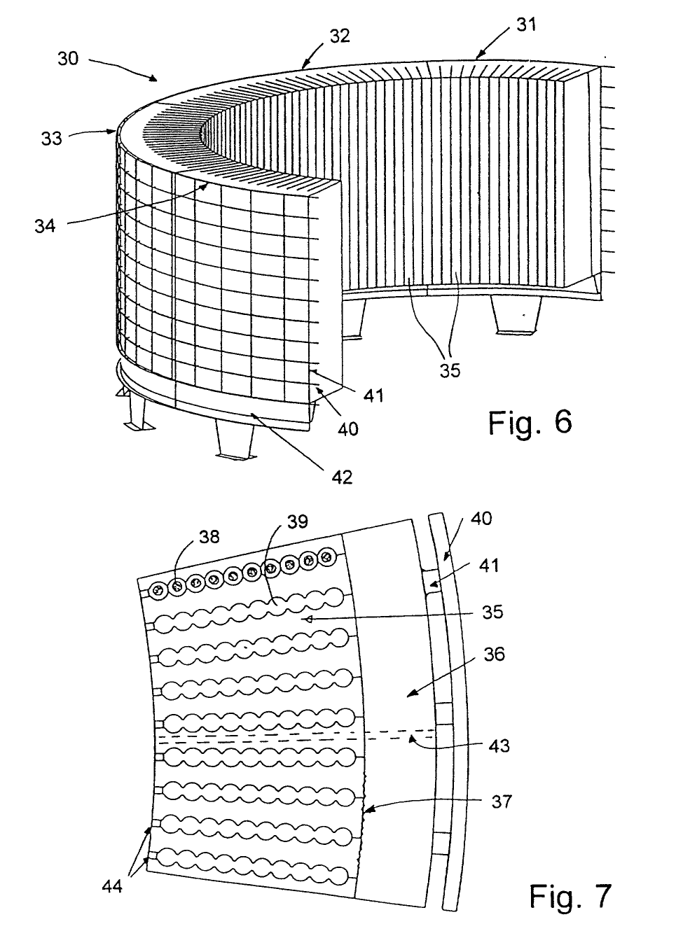

FIG. 6 shows a partial schematic view in perspective of a second embodiment of a stator,

FIG. 7 shows a section of the stator in FIG. 6,

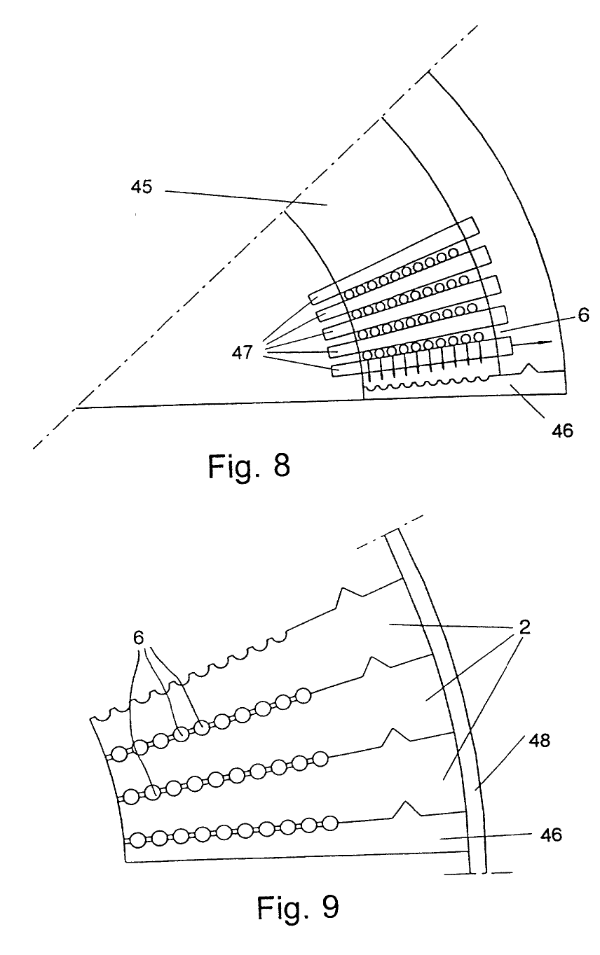

FIG. 8 shows a schematic view of a production fixture in accordance with the present invention,

FIG. 9 shows a schematic view of a part of a third embodiment of a stator manufactured in accordance with the present invention, and

FIG. 10 shows a schematic cross section view of a cable.

It should be noted that, for corresponding elements in the different figures, the same reference numerals have been used.

FIG. 1 shows a schematic drawing of a stator, and its stator core 1, for a rotating electric machine. The stator core is built from a number of substantially wedge-shaped stator tooth planks 2, constituting stator teeth 3 with a forward tooth portion 4, with slots for the winding, and a yoke portion 5, without slots. Said stator tooth planks 2 have been assembled into the cylindrical shape illustrated in FIG. 1. The stator is further provided with a stator winding 6 located in axially extending slots, radially distributed in the stator, between the teeth. The stator winding is shown in FIG. 1 as radially marked lines representing these radially distributed winding slots with the winding 6. A preferred embodiment of the invention includes a stator provided with a stator winding 6 comprising a high voltage cable located in a space, of what may be described as a bicycle chain shape, configured between each individual stator tooth.

FIGS. 2a and 2b illustrate two variants of a substantially wedge-shaped tooth section or partial tooth 7, which form a first building element, said stator tooth plank being assembled of a number of said tooth sections and each tooth section 7 representing a slot pitch where the pitch plane cuts through the centre of the radially distributed slots 8. In a machine, according to the present invention, the ventilation ducts may be formed when the tooth sections 7 are assembled into a stator tooth plank 2. When doing this, ventilation ducts and cooling ducts may be achieved by placing spacer elements between the tooth sections 7.

It should be pointed out that by the expression “stator tooth section” is intended an element of a certain thickness. If the stator core is of the type built from laminated electrical sheets, each stator tooth section would comprise a number of layers of laminated electrical sheet, generally several hundreds of layers of electrical sheet. This is necessary in order to provide an element with a sufficient stiffness to allow and withstand the necessary handling according to the invention. Accordingly, an example of a suitable size or thickness of a tooth section, when providing cooling ducts, may be 50-100 mm, wile an example of a suitable size of a tooth section determined by transportation limitations may be 100-1000 mm. These sizes would also be feasible for other types of stator core tooth sections, for example made of compacted magnetic powder.

According to the first variant of the tooth section, illustrated in FIG. 2a, the lateral sides, facing adjacent teeth, of the yoke portion of the tooth section are straight or plane. According to the second variant, illustrated in FIG. 2b, each tooth section 7 is provided with a first guiding means 9 in the form of a recess in one of the lateral sides, facing an adjacent tooth, of the yoke portion 5 of the tooth section. Each tooth section 7 is also provided with a second guiding means 10 in the form of a shoulder that fits into said recess, i.e. the first guiding means 9 and the second guiding means 10 are configured with corresponding shapes such that they fit into each other when two teeth sections are placed beside each other. FIG. 2b shows these guiding means as being triangular but other shapes are naturally possible.

FIGS. 3a and 3b illustrate more in detail two variants of a stator tooth plank 2 constituting a second building element representing a stator tooth 3, which is produced by means of a number of axially assembled tooth sections 7, in accordance with either one of the two variants represented in FIGS. 2a and 2b, respectively. For this assembly a certain fixture or a special tool may be used in/with which each tooth section is fitted into the right position in relation to the other tooth sections. If guiding means 9, 10 are provided, they will facilitate this fitting operation. After this fitting an adhesive is supplied to the contact surfaces followed by an axial compression.

A first embodiment of a stator according to the present invention is illustrated in FIGS. 4 and 5. The stator comprises a number of stator teeth 3 (or tooth planks) assembled into core sections, which are thereafter assembled together within a stator frame 12. The assembly of the teeth is preferably made by means of a special tool comprising a number of cylindrical sticks, which are sufficiently long to hold and guide the planks when they are assembled one by one. The number of teeth in one core section may vary from one and upwards. The illustrated stator includes four core sections 1A, 1B, 1C, 1D.

Between the lateral sides of the yoke portions 5 of the teeth there is provided a lining 13 of a resilient material. The lining 13 may either be a lining of resilient material attached directly on the side of one or both teeth in each pair of adjacent teeth, or it may be a separate lining element inserted between the teeth. The resilient material will provoke a small gap or play between the two adjacent teeth, thereby making the slot 8 openings for the winding 14 larger. Consequently, more space will be available for the winding and the insertion of the winding is facilitated.

A lining 15 of a resilient material may also be provided between the external circumferential side of the yoke portion 5 of the teeth 3 and the stator frame 12 surrounding the teeth. This lining may either be attached to the teeth or the inside of the stator frame.

The stator frame may comprise several frame sections. In the embodiment illustrated in FIG. 4, four frame sections 12A, 12B, 12C, 12D have been schematically suggested. The number of frame sections does not necessarily have to correspond to the number of core sections. Between the frame sections longitudinal axial openings 17 are created. The frame sections are connected, in order to form an annular frame, by a means 18 which also functions as a tightening means and which serves to tighten the frame around the core by reducing said openings. This combined connection and tightening means 18 is preferably a bolted joint.

In the detailed illustration of FIG. 5, the stator frame is provided with an axial opening 17 extending along the entire length of the frame. In order to adjust this opening and thereby press together the teeth 3 and also compress the linings 13, 15, the frame is provided with a tightening means, in the form of a bolted joint 18. When the bolted joint is tightened this occurs against the action of the resilient material in the linings. The tightening of the joint also results in that the windings 14 are pressed against the walls of the slots 8, which, as the cable in the winding is provided with an outer semiconducting layer, leads to the winding being connected to, for example, ground. Associated with the tightening means 18, there is also a springing means 20, by means of which the opening/openings in the stator frame and the winding slots are automatically adjusted to thermal expansions and contractions of the winding. Preferably, this springing means is configured as a cup spring, which is compressed when the winding is subjected to thermal expansion in the slots and expanded when the winding is subjected to thermal contraction. Through this arrangement the winding will continuously be in contact with the walls of the slot, without any risk of being deformed when subjected to thermal expansion since the winding slot will automatically adjust to the cross section of the cable thanks to said spring.

Along the inside of the stator teeth, at the air gap end of the slots, i.e. the internal circumference facing the rotor, the teeth are provided with notches 22, as a prolongation of the slots at the air gap, into which key elements 23 are driven. Only one key element has been illustrated in FIG. 5. These key elements are preferably shaped as wedges but also other designs may be used. The purpose of these keys is to prevent lateral oscillations of the tooth planks and to generally improve the stiffness and stability of the stator core. The wedges are of a non-magnetic material, such as glass fibre reinforced epoxy, plastic etc. and they are prestressed when the frame is tightened or by means of the prestressing structure. The wedges may have a slightly arched shape in order to function as a spring. The notches 22 may be provided with a lining of a resilient material, such as rubber. The purpose of the lining is to maintain the compressive prestresses between adjacent stator teeth when the distance between said stator teeth is changed due to thermal expansion or contraction of the winding.

A second embodiment of a stator according to the invention is represented in FIGS. 6 and 7. In this embodiment the traditional stator frame has been excluded. The illustrated stator comprises a stator core 30 built from six core sections 31, 32, 33, 34, of which only four are represented in the figure. Each section is built form a number of stator teeth 35, preferably in the form of tooth planks as described above. However, it should be noted that the radial length of the yoke portion of these teeth may vary, and in this embodiment the stator is provided with a stator yoke 36 externally and circumferentially of the teeth, which has not been the case in the previously described embodiment. Naturally, the provision of a separate stator yoke or not, and the size of the yoke portion of the teeth are choices to be made on a case to case basis. This embodiment would normally require that also the stator yoke is divided into sections.

In order to obtain a sufficient stiffness and stability of the core section with windings, the teeth are tangentially compressed using wedges 44, as described above. Contact between teeth shall also be provided at the yoke (rear) end, either by direct contact or by using a spacer means. There is a smooth contact surface 37 between the yoke end of the teeth and a yoke portion 36 of the core arranged circumferentially along the yoke end of the teeth. The compressive force is given by pre-tension provided by steel rods 40 or wires arranged at the outside of the stator yoke. The compressive force is distributed to the core via axial steel brackets 41, which may be welded to the outside yoke portion of the core. The tension force in the wires 40 is balanced by tangential compressive forces in the wedges 44 between tooth parts at the air gap and at the yoke end of the tooth. The yoke end of the teeth 35 may be glued to the stator yoke 36 for increased load capacity, or for practical reasons such as obtaining teeth and yoke of the stator core in one piece. As an alternative, the surface 37 may be subjected to a suitable surface treatment or some sort of pad or lining may be provided in order to increase friction.

It should be noted that the teeth and stator yoke in this embodiment may be substituted for teeth which incorporate the stator yoke in a yoke portion, such as the teeth illustrated in FIG. 9, with or without guiding means.

The core is supported on a steel frame 42 at its base. In FIG. 7 may also be seen a cooling duct 43.

FIG. 8 is intended to illustrate how the stator teeth 47 (in the form of stator tooth planks) may be assembled into a stator core section or a complete stator core, using a stator fixture 45. The stator fixture 45 is arranged, with a curve form corresponding to the finished stator, to include a fixture tooth 46 as an initial fixture element shaped as half a stator tooth plank. A first stator tooth plank 2 may possibly be used to start with as this initial fixture element. Furthermore, the stator fixture 45 is arranged to hold removably inserted temporary stator teeth 47 with the correct pitch during assembly. These teeth are wedge-shaped like the stator teeth planks, but are slimmer in order to leave space for the stator winding 6 between each temporary stator tooth 47.

The stator is manufactured by:

a) removably inserting at least one of the temporary stator teeth 47 in a fixture 45 corresponding to a section of, or a complete stator core,

b) inserting the stator winding 6 of at least one winding slot, shown in FIG. 8 as a section through ten parallel winding parts, above the temporary stator tooth 47,

c) removing the temporary stator tooth 47 from the fixture and allowing the winding in the winding slot to fall down or pressing it down to assume its correct position in a first permanent winding slot in either a fixture tooth 46 or a stator tooth plank 2,

d) inserting a stator tooth plank 2, fitting it above the first winding slot thus formed and securing it against a previously fitted stator tooth plank 2,

e) thereafter repeating steps a) through d) until a section of or a complete stator has been assembled.

According to another method of manufacturing the stator, all the temporary stator teeth are placed in the fixture, one after another, with the stator winding inserted after each temporary stator tooth. Assembly is then performed by removing the lowermost of the remaining temporary stator teeth 47 from the fixture and allowing the winding in the slot to fall down, or pressing it down so that it assumes a correct position in an adjacent winding slot in either the fixture tooth 46 or in each subsequent stator tooth plank 2. This is repeated until a section or a complete stator core has been produced. The distance from the fixture tooth/first stator tooth plank to the nearest temporary stator tooth inserted is selected so that a stator tooth plank 2 can be fitted over the first winding slot after the temporary stator tooth has been removed and the winding parts have fallen or been pressed into place. As can be seen from the manufacturing method described above, the stator windings may either be placed in a fixture slot by slot or may be completed in the fixture for the section to be produced. A combination of these two manufacturing methods is also covered by the appended claims. The whole stator may possibly be manufactured by arranging the fixture to rotate half a turn, in which case each new stator tooth plank is secured against the previous one. Irrespective of whether one section or the whole stator is being assembled, each stator tooth plank is joined at its yoke portion 5 by means of gluing and a specially provided pressure joint.

FIG. 9 shows three stator tooth planks 2 combined with the stator winding 6 in the slot therebetween. The first stator tooth plank is removably placed against the intermediate stator winding 6 and against the fixture tooth 46, whereas each subsequent stator tooth plank is fixed to a previous one. If a complete stator is being manufactured as one unit, the last stator tooth plank to be fitted will be inserted after tangential expansion of the stator. The stator is then tightened again. Irrespective of which manufacturing method is used, the finished stator core will be compressed by some type of compressing means. In FIG. 9 these compressing means are illustrated, according to a third embodiment, as a number of clamping rings or hoops 48 of the type used for barrels. The compressing means may in addition also comprise a conventional stator frame, or the type of steel rod/wire arrangement that has been described above.

The tooth planks 2 illustrated in FIG. 9 are of the type illustrated in FIG. 3b including guiding means. Naturally, they may instead be of the type illustrated in FIG. 3a, without any special guiding means. In the same manner may the teeth illustrated in FIGS. 4-7, which are of the type without a guiding means as illustrated in FIG. 3a, be exchanged for the type of teeth illustrated in FIG. 3b, with guiding means.

Finally, in FIG. 10 is represented a cable which is particularly suitable to be used as a winding in the stator according to the invention. The cable 50 includes at least one current-carrying conductor 51 surrounded by a first semiconducting layer 52. Outside said first layer is provided a layer of solid insulation 53. Surrounding the insulation layer is then provided a second semiconducting layer 54. The current-carrying conductor may include a number of strands 56, of which at least some are insulated from each other. The three layers of the cable, i.e. the two semiconducting layers and the insulation layer, are arranged to adhere to each other even when the cable is bent. The cable is consequently flexible and this property is maintained during the entire life of the cable. The illustrated cable also differs from conventional high voltage cables in that it does not include any outer layer for mechanic protection of the cable, nor does it include any metal shield which normally is provided on such a cable.

The above description of preferred embodiments of the invention is only intended as illustrating examples, without limiting the invention. A number of modifications of the present invention may naturally be conceivable within the scope of the following patent claims.

1. A stator for a rotating electric machine for high voltages, comprising a stator, with a stator core and a winding, and a rotor, wherein said stator core is provided with stator teeth extending radially inwards, towards said rotor, characterized in that each stator tooth (3) is configured as a number of tooth sections (7) joined axially into a stator tooth plank (2) and that a number of stator tooth planks are fitted together side by side thus forming a section (1A, 1B, 1C, 1D; 31, 32, 33, 34) of a stator core or a complete stator core, and that an electric field is generated which is enclosed within the winding (6; 14; 38) for at least one turn of the winding.

2. A stator according to claim 1, characterized in that a number of the sections (1A, 1B, 1C, 1D; 31, 32, 33, 34) of a stator core are joined together in order to achieve a complete stator core.

3. A stator according to any one of the preceding claims, characterized in that said winding is provided by means of an insulated conductor (50) which comprises at least one current-carrying conductor (51), a first layer (52) having semiconducting properties provided around said conductor, a solid insulating layer (53) provided around said first layer, and a second layer (54) having semiconducting properties provided around said insulating layer.

4. A stator according to claim 3, characterized in that the stator winding is provided by means of a cable, preferably a high voltage cable.

5. A stator according to any one of claims 3-4, characterized in that said insulated conductor (50) or said cable is flexible.

6. A stator according to any one of claims 3-5, characterized in that said second layer (54) is arranged to constitute a substantially equipotential surface surrounding said conductor.

7. A stator according to any one of claims 3-6, characterized in that said second layer (54) is connected to a predetermined potential.

8. A stator according to claim 7, characterized in that said predetermined potential is ground potential.

9. A stator according to any one of claims 3-8, characterized in that at least two adjacent layers have substantially equal thermal expansion coefficients.

10. A stator according to any one of claims 3-9, characterized in that each of said three layers (52, 53, 54) is solidly connected to the adjacent layer along substantially the whole connecting surface.

11. A stator according to any one of claims 3-10, characterized in that said layers (52, 53, 54) are arranged to adhere to one another even when the insulated conductor or cable is subjected to a bending force.

12. A stator according to any one of the preceding claims, characterized in that the stator winding (6) is arranged to be inserted between each stator tooth plank (2) before they are fitted together to form a section of a stator core or to form a complete stator core.

13. A stator according to any one of the preceding claims, characterized in that the stator tooth (3) comprises a forward tooth portion (4) facing inwards, towards the rotor, when mounted in the stator, and a yoke portion (5) facing outwards, that said stator tooth has two opposite lateral sides each facing the corresponding side of an adjacent stator tooth, that the lateral sides of the tooth portion (4) facing inwards are provided with slots (8) for the winding and that at least one of the lateral sides of the yoke portion (5) is provided with a lining (13) made of a resilient material.

14. A stator according to any one of the preceding claims, characterized in that the stator tooth comprises a forward tooth portion (4) facing inwards, towards the rotor, when mounted in the stator and a yoke portion (5) facing outwards, that said stator tooth has two opposite lateral sides each facing the corresponding side of an adjacent stator tooth, that the lateral sides of the tooth portion facing inwards is provided with slots (8) for the winding, and in that it further comprises a separate lining element (13) of a resilient material which is inserted between the lateral sides of the yoke portions (5) of two adjacent stator teeth.

15. A stator according to any one of the preceding claims, characterized in that at least one longitudinal axial notch (22) is arranged in the tooth (3; 35), along its innermost side and facing the rotor, that a key element (23; 44) of a non magnetic material is positioned in said notch in order to prevent lateral oscillations of said tooth and/or the adjacent tooth.

16. A stator according to claim 15, characterized in that the notch (22) is provided with a lining of a resilient material.

17. A stator according to any one of the preceding claims, characterized in that it comprises compressing means (12; 40, 41; 48) for tangentially compressing the teeth (3; 35) of the stator, thereby providing a prestressing at the innermost end of the teeth.

18. A stator according to claim 17, characterized in that the compressing means includes a stator frame (12).

19. A stator according to any one of the preceding claims, characterized in that the stator core sections (1A, 1B, 1C, 1D) of the complete stator core are held in place by means of an annular stator frame (12), surrounding said core.

20. A stator according to claim 18-19, characterized in that the stator core section is provided with a lining (15) of a resilient material on the external side of the yoke portion (5) of said tooth (3), which is in contact with the stator frame (12).

21. A stator according to any one of claims 18-20, characterized in that the stator frame (12) is provided with a lining (15) of a resilient material on its inward facing surface, which is in contact with the external side of the yoke portions (5) of the stator teeth (3).

22. A stator according to any one of claims 18-21, characterized in that the stator frame (12) is provided with at least one longitudinal axial opening (17) and that said stator frame includes at least one means (18) for tightening said frame around the stator core (1) by means of reducing said opening.

23. A stator according to any one of claims 18-22, characterized in that the stator frame is divided into at least two frame sections (12A, 12B, 12C, 12D), that a longitudinal axial opening (17) is created between the frame sections, and that means (18) are provided connecting the frame sections and for tightening said frame around the stator core (1) by means of reducing said openings.

24. A stator according to any one of claims 22-23, characterized in that said means (17) for tightening the stator frame includes a bolted joint and that said bolted joint works against the action of the resilient material in the linings (13, 15) and/or lining elements.

25. A stator according to any one of claims 22-24, characterized in that the stator frame (12) further includes a springing means (20) associated with said tightening means (18), and that by means of said springing means the opening/openings (17) in the stator frame and the winding slots (8) are automatically adjusted to thermal expansions and contractions of the winding.

26. A stator according to claim 25, characterized in that the springing means (20) includes a cup spring.

27. A stator according to any one of claims 17, characterized in that the compressing means includes a structure of prestressing means (40), arranged along the circumference of the core (30), and brackets (41) arranged axially for distributing the compressive force to the core.

28. A stator according to claim 27, characterized in that the prestressing means includes rods or wires (40).

29. A stator according to any one of claims 27-28, characterized in that the external side of the yoke portions (5) of the teeth (3) are in contact with a stator yoke portion (36), arranged along said yoke portions, and that a friction means (37) is provided at the contact surface between said external side of the yoke portions and said stator yoke portion.

30. A stator according to any one of claims 17-28, characterized in that the compressing means include at least one clamping ring (48) applied circumferentially around the stator core.

31. A stator according to any one of claims 27-30, characterized in that it further comprises a base (42) upon which the core is supported.

32. A stator according to any one of claims 13-31, characterized in that the resilient material is rubber.

33. A stator according to any of the preceding claims, characterized in that each tooth section (7) and thus each stator tooth plank (2) is provided on both lateral sides with guiding means (9, 10) designed to fit against corresponding guiding means of corresponding shape on adjacent stator tooth planks (2).

34. A method for use in the manufacturing of a stator for a rotating electric machine for high voltages, comprising a stator, with a stator core (1; 30) and a winding (6; 14; 38), and a rotor, wherein said stator core (1; 30) is provided with stator teeth (3; 35) extending radially inwards, towards said rotor, characterized in:
axially joining a number of tooth sections (7) into a stator tooth plank (2), thereby forming said stator tooth (3),
fitting, side by side, a number of stator tooth planks (2), thereby forming a section (1A, 1B, 1C, 1D; 31, 32, 33, 34) of a stator core or a complete stator core, and
providing a winding (6; 14; 38) within which a generated electric field is enclosed for at least one turn of said winding.

35. A method according to claim 34, characterized in joining together a number of sections (1A, 1B, 1C, 1D; 31, 32, 33, 34) of a stator core in order to achieve a complete stator core.

36. A method according to any one of the preceding claims, characterized in providing a winding as described in any one of claims 3-11.

37. A method according to any one of the preceding claims, characterized in that
a) an initial fixture element, e.g. in the form of a stator tooth plank (2) or a fixture tooth (46) is removably placed in a manufacturing fixture (45),
b) at least one temporary stator tooth (47) is removably inserted in the fixture (45),
c) a stator winding (6) is inserted on the temporary stator tooth or teeth (47) situated closest to fixture element (2, 46)
d) the temporary stator tooth (47) situated closest to the fixture element (2, 46) is removed from the manufacturing fixture (45), allowing the stator winding (6) placed on the temporary stator tooth (47) to fall or be pressed down and assume its correct position in a first winding slot in the fixture element (2, 46),
e) a stator tooth (3) is inserted into the manufacturing fixture (45) and fitted over the stator winding (6),
f) steps a) through e) are repeated until a section of or a complete stator core has been produced.

38. A method according to claim 37, characterized in that each stator tooth plank (2) is glued to a previously fitted stator tooth plank (2) at its yoke portion (5) after step d).

39. A method according to claim 37, characterized in that each stator tooth plank (2) is glued to a previously fitted tooth plank (2) at its yoke portion (5) after a section of or a complete stator core has been manufactured.

40. A method according to any of claims 37-39, characterized in that during manufacture of the stator the fixture (45) is rotated about a horizontal axis corresponding to the axial symmetry axis of the stator.

41. A method according to any of claims 37-40, characterized in that the stator windings (6) are joined to define the intended number of poles and phases.

42. A method according to any one of the preceding claims, characterized in providing a lining (13) of resilient material to the yoke portion (5) of at least one of two opposite lateral sides of a stator tooth (3) facing the corresponding side of an adjacent stator tooth, preferably before the fitting.

43. A method according to any one of the preceding claims, characterized in inserting a lining element (13) of resilient material between the lateral sides of the yoke portions (5) of two adjacent stator teeth (3), before or after the fitting.

44. A method according to any one of the preceding claims, characterized in inserting key elements (23; 44) of a non magnetic material between the tooth planks (2), at the forward end of the teeth (3; 35) facing the rotor, in notches (22) provided for this purpose in the stator tooth planks.

45. A method according to claim 44, characterized in providing a lining of a resilient material inside the notch.

46. A method according to any one of the preceding claims, characterized in applying compression means (12; 40, 41; 48) for tangentially compressing the teeth (3; 35) of the stator, thereby providing a prestressing at the innermost end of the teeth.

47. A method according to any one of the preceding claims, characterized in providing a lining of a resilient material (15) to the external side of the yoke portion (5) of the stator tooth.

48. A method according to any one of the preceding claims, characterized in providing a lining of a resilient material (15) to the inwardly facing surface of a stator frame (12), which enters into contact with the external sides of the yoke portions (5) of the stator teeth (3).

49. A method according to any one of the preceding claims, characterized in assembling the stator core sections (1A, 1B, 1C, 1D) into a complete stator core within a stator frame.

50. A method according to any one of claims 47-49, characterized in tightening the stator frame (12), which constitutes said compression means, and surrounding the stator core whereby the resilient material (13, 15) is compressed and the winding (14) is pressed against the walls of the slots (8).

51. A method according to any one of claims 34-46, characterized in providing a friction means (37) at the contact surface between the external side of the yoke portions of the teeth (35) and a stator yoke portion (36) arranged circumferentially along said external side of the yoke portions.

52. A method according to any one of claims 46 or 51, characterized in fitting the core sections together under compression by means of a structure, which constitutes said compression means, comprising prestressing means (40), arranged along the circumference of the core (30), and brackets (41) arranged axially for distributing the compressive force to the core.

53. A method according to any one of claims 46-52, characterized in fitting the core sections together under compression by means of applying at least one clamping ring (48), which constitutes said compression means, circumferentially around the core.

54. A method according to any one of the preceding claims, characterized in inserting the winding (6; 14; 38) in the axial direction of the stator core.

55. A method according to any one of the preceding claims, characterized in manufacturing the stator on the site of installation of the rotating electric machine.

56. A stator for a rotating electric machine, characterized in that it is manufactured in accordance with the method in any one of claims 34-55.

57. A rotating electric machine for high voltages, including a rotor and a stator according to any one of claims 1-33, or 56.
